(19) United States
(12) Patent Application Publication
(10) Pub. No.: US 2004/0119409 A1
(43) Pub. Date: Jun. 24, 2004

(54) LED based lamp device for advertisements and night lighting

(76) Inventor: Toru Kubota, Hong Kong (HK)

Correspondence Address: RABIN & BERDO, P.C., Suite 500, 1101 14th Street, N.W., Washington, DC, 20005, US

(21) Appl. No.: 10/654,902

(22) Filed: Sep. 5, 2003

(30) Foreign Application Priority Data
Dec. 6, 2002 (CN) 02287495.X

(51) Int. Cl. H01J 1/62

(52) U.S. Cl. 313/512

(57) ABSTRACT

A LED based advertising lamp device comprising a container and several LEDs within it, wherein said LEDs are placed upside down in the reflecting substance coated bottom, as a light reflection surface, of said container having remaining space therein to fill with transparent resin. The technical scheme according to the utility model is applicable for implementing as advertising lantern assemblies and character patterns with various colours and shapes to shine softly and brightly without dazzle and many LED spots visible.

### BACKGROUND OF INVENTION

The utility model relates to an advertising lamp device and, in particular, to a lamp device with LEDs for advertisements.

### DESCRIPTION OF RELATED ART

Nowadays, a LED (light emitting diode) based advertising lamp device typically comprises a container and several LEDs within it. However, these LEDs are placed in their normal posture within the container such that the dazzle light directly transmitted from a visible surface of the container by them and their perceptible spots result in undesirable visual effect. Although light effect is enhanced by some manufacturers based on reflected light and an additional transparent shade, the dazzle light and perceptible LED spots exit.

### SUMMARY OF INVENTION

Thus, an object of the utility model is to eliminate above-mentioned defects in prior art, and provide a novel LED based advertising lamp device.

To achieve the object said above, according to an aspect of the utility model, a LED based advertising lamp device comprising a container and LEDs therein is characterized in that said LEDs are placed upside down on the reflecting substance coated bottom, as a light reflection surface, of said container having remaining space therein to fill with transparent resin.

Furthermore, colour fluorescent powders are mixed into said transparent resin with 1/4˜1/3 of thickness approaching to the visible surface at the top of said container, or other desired thickness.

Said fluorescent powders are red, blue, yellow, green or other desired colours.

The internal wall of said container is also a reflecting substance coated light reflection surface.

According to the utility model, an advertising lantern assembly including said LED based lamp device is further provided.

The active and advanced effect in accordance with the utility model lies in that it is applicable to implement advertising lantern assemblies and character patterns with various colours and shapes to shine softly and brightly without dazzle and many LED spots visible.

### BRIEF DESCRIPTION OF DRAWINGS

Further objects, features and advantages of the utility model will be apparent from the following detailed description taken in conjunction with drawing for reference, wherein

FIG. 1 is a schematic view showing the cross section of a preferred embodiment according to the utility model; and

FIG. 2 is a schematic view showing an advertising lantern assembly implemented by the utility model.

### DESCRIPTION OF PREFERRED EMBODIMENT

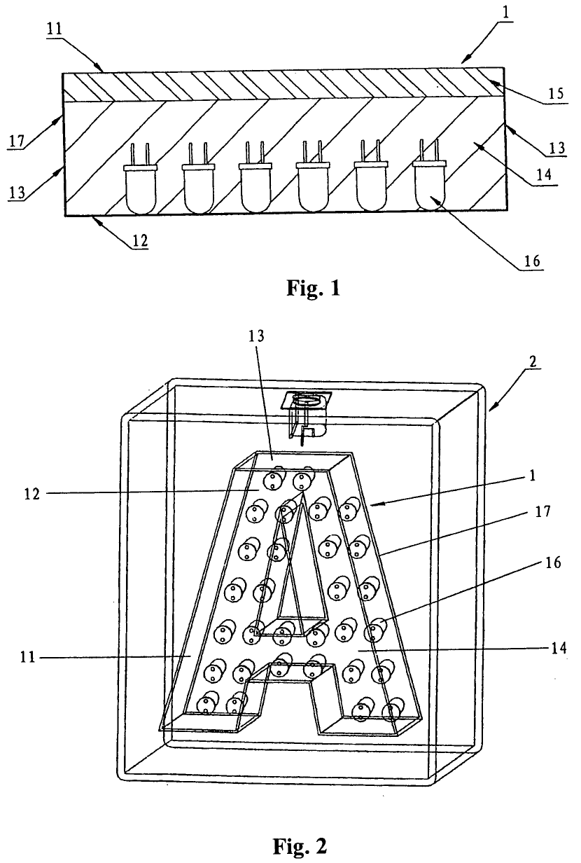

Referencing to FIG. 1, a LED based adverting lamp device 1, in accordance with the utility model, comprises a container 17 and a number of LEDs 16 within it. Furthermore, for the container 17, except its bottom is arranged for the LEDs 16 placed upside down, the remaining space is filled with transparent resin 14 having 1/4 of thickness approaching to the visible surface 11 at the top of container 17 to mix by colour fluorescent powers. In the container 17, both the bottom surface 12 and side wall 13 are implemented as a light reflection surface coating with white paint (i.e.reflecting substance).

Next, with reference in FIG. 2, a lantern assembly 2 implemented by using the LED based advertising lamp device 1 is shown.

The procedures for making a LED based advertising lamp device 1, taken alphabet “A” for example, are as follows:

(1) making an “A”-shape hollow container from plastics based on the dimension required, and spraying white paint on both side wall and bottom surface to form reflection surfaces;

(2) arranging and fitting the LEDs evenly on the bottom of the container with equally spaced each other and their light emitting faces downward;

(3) connecting the LEDs and coupling them to positive and negative poles of power supply respectively;

(4) pouring transparent epoxy into the container to fill all range in it other than the required space away from its top; and

(5) pouring again colour resin mixed with fluorescent powder into the remaining top space.

1. A LED based advertising lamp device comprising a container and several LEDs within it, wherein said LEDs are placed upside down in the reflecting substance coated bottom, as a light reflection surface, of said container having remaining space therein to fill with transparent resin.

2. The LED based adverting lamp device set forth in claim 1, wherein colour fluorescent powders are mixed into said transparent resin with 1/4˜1/3 of thickness approaching to the visible surface at the top of said container, or other desired thickness.

3. The LED based adverting lamp device set forth in claim 1, wherein said fluorescent powders are red, blue, yellow and green.

4. The LED based adverting lamp device set forth in claim 1, wherein the internal wall of said container is also a reflecting substance coated light reflection surface.

5. An advertising lantern assembly including said LED based advertising lamp device set forth in claim 1.

6. An advertising lantern assembly including said LED based advertising lamp device set forth in claim 2.

7. An advertising lantern assembly including said LED based advertising lamp device set forth in claim 3.

8. An advertising lantern assembly including said LED based advertising lamp device set forth in claim 4.
